(19) United States
(12) Patent Application Publication
(10) Pub. No.: US 2021/0086792 A1
(43) Pub. Date: Mar. 25, 2021

(54) METHOD OF ASSISTING A MOTOR VEHICLE

(71) Applicant: Robert Bosch GmbH, Stuttgart (DE)

(72) Inventor: Stefan Nordbruch, Kornwestheim (DE)

(21) Appl. No.: 17/023,306

(22) Filed: Sep. 16, 2020

(30) Foreign Application Priority Data
Sep. 23, 2019 (DE) 102019214448.9

(51) Int. Cl. B60W 60/00; G05D 1/00; B60W 50/04; B60W 50/029; B60W 40/04; B60W 30/095; B60W 40/06; B60W 30/09

(52) U.S. Cl. CPC B60W 60/0017; G05D 1/0022; B60W 50/045; B60W 50/029; B60W 40/04; B60W 30/0956; B60W 2556/45; B60W 30/09; B60W 2552/00; B60W 2554/406; B60W 2420/42; B60W 2420/52; B60W 2555/20; B60W 40/06

(57) ABSTRACT

A method of assisting a motor vehicle driven in an at least semiautomated manner, for passing through a road construction site. The method includes: receiving surrounding-area signals, which represent a surrounding area of the motor vehicle, the surrounding area of the motor vehicle including at least part of a road construction site; receiving safety condition signals, which represent at least one safety condition that must be satisfied, so that the motor vehicle may be assisted from outside of the motor vehicle while passing through the road construction site; checking if the at least one safety condition is satisfied; generating data signals, which represent data suitable for assisted traversal of the road construction site by the motor vehicle, based on the surrounding-area signals, and based on a result of whether the at least one safety condition is satisfied; and outputting the generated data signals.

### CROSS REFERENCE

The present application claims the benefit under 35 U.S.C. § 119 of German Patent Application No. DE 102019214448.9 filed on Sep. 23, 2019, which is expressly incorporated herein by reference in its entirety.

### FIELD

The present invention relates to a method of assisting a motor vehicle driven in an at least semiautomated manner for passing through a road construction site. In addition, the present invention relates to a device, a computer program and a machine-readable storage medium.

### BACKGROUND INFORMATION

German Application No. DE 11 2014 001 058 T5 and PCT Application No. WO 2014/148975 describe a method and a system for controlling autonomous vehicles.

German Patent Application No. DE 10 2014 213 171 A1 describes a system for driving a vehicle autonomously.

PCT Application No. WO 2019/028464 A1 describes a method for automatically controlling activation and deactivation of an autonomous mode of vehicles.

### SUMMARY

An object of the present invention is to provide for efficiently assisting a motor vehicle driven in at least semiautomated manner for passing through a road construction site.

This object may be achieved with the aid of example embodiments of the present invention. Advantageous refinements of the present invention are described herein.

According to a first aspect of the present invention, a method of assisting a motor vehicle driven in an at least semiautomated manner for passing through (and/or, in particular, while passing through) a road construction site is provided. In accordance with an example embodiment of the present invention, the method includes the following steps:

receiving surrounding-area signals, which represent a surrounding area of the motor vehicle, the surrounding area of the motor vehicle including at least part of a road construction site;

receiving safety condition signals, which represent at least one safety condition that must be satisfied, so that the motor vehicle may be assisted from outside of the motor vehicle while passing through the road construction site;

checking if the at least one safety condition is satisfied;

generating data signals, which represent data suitable for assisted traversal of the road construction site by the motor vehicle, based on the surrounding-area signals, and based on a result of whether the at least one safety condition is satisfied;

outputting the generated data signals.

According to a second aspect of the present invention, a device is provided, which is configured to execute all of the steps of the method according to the first aspect.

According to a third aspect of the present invention, a computer program is provided, which includes commands that, in response to the execution of the computer program by a computer, for example, by the device according to the second aspect, cause it to implement a method according to the first aspect.

According to a fourth aspect of the present invention, a machine-readable storage medium is provided, in which the computer program according to the third aspect is stored.

The present invention is based on the knowledge, and incorporates this as well, that the above-mentioned object may be achieved by assisting the motor vehicle during traversal of a road construction site. For this, in particular, data, which are suitable for assisting, are generated and outputted to the motor vehicle and/or transmitted to the motor vehicle. This may produce, for example, the technical advantage that the motor vehicle may be assisted in an efficient manner while passing through the road construction site.

Since these data are generated as a function of a result of a check as to whether the at least one safety condition is satisfied, it may be ensured, in particular, in an advantageous manner, that the data may be generated in a safe setting. Thus, for example, it may be efficiently ensured that the data may not be manipulated. This may ensure, for example, an advantageous manner, that the data may be transmitted, safe from manipulation, to the motor vehicle.

Therefore, this means, in particular, that the motor vehicle may rely on these data, if, for example, it passes through the road construction site on the basis of these data.

This may produce, for example, the technical advantage that an accident risk for the motor vehicle and/or for road users in the surroundings of the motor vehicle may be reduced.

Thus, this may produce, in particular, the technical advantage that an efficient concept is provided for efficient, at least assisted, traversal of a road construction site by a motor vehicle driven in an at least semiautomated manner.

In the spirit of the description herein, assisting is assisting outside of the motor vehicle, for example, using a construction site infrastructure. Assisting includes, in particular, the generating of the data signals and the outputting of the data signals.

One specific embodiment of the present invention provides a step of determining that a motor vehicle driven in an at least semiautomated manner is expected to pass through a road construction site.

For example, the surrounding-area signals are processed, in order to detect a motor vehicle, which is being driven in an at least semiautomated manner and intends to travel through the road construction site.

In response to the detection of a motor vehicle, which is being driven in at least semiautomated manner and intends to travel through the road construction site, it is determined, for example, that a motor vehicle driven in an at least semiautomated manner wishes to travel through or traverse the road construction site.

According to one specific embodiment of the present invention, the data include a driving requirement, which the motor vehicle is supposed to follow.

A technical advantage of this is, for example, that the assisting may be carried out efficiently.

According to one specific embodiment of the present invention, the driving requirement is directed to a driver of the motor vehicle.

According to one specific embodiment of the present invention, the driving requirement is directed to the motor vehicle itself. Thus, this means, in particular, that the driving requirement is intended to be implemented or followed by the motor vehicle independently, that is, in particular, autonomously.

According to one specific embodiment of the present invention, the driving requirement includes remote control commands for controlling a lateral and/or longitudinal guidance of the motor vehicle remotely.

This may produce, for example, the technical advantage that the driving requirement may be implemented efficiently. Therefore, this means, in particular, that according to this specific embodiment of the present invention, the motor vehicle is controlled remotely on the basis of the driving requirement. The remote control means that, in particular, the lateral and/or longitudinal guidance of the motor vehicle is controlled remotely. Therefore, the remote control is carried out, in particular, on the basis of the remote control commands.

The assisting of the motor vehicle from outside of the motor vehicle during the traversal of the road construction site includes, in particular, the case, in which only the lateral guidance or only the longitudinal guidance of the motor vehicle is controlled remotely, or both the lateral guidance and the longitudinal guidance of the motor vehicle are controlled remotely.

In the case, in which remote control signals are intended for controlling the lateral or the longitudinal guidance of the motor vehicle, one specific embodiment provides that in each instance, the other guidance, that is, the longitudinal guidance or the lateral guidance, be either controlled manually by the driver of the motor vehicle or controlled in an at least semiautomated manner, in order to drive the motor vehicle in an at least semiautomated manner for passing the motor vehicle through with assistance.

The wording “at least semiautomated driving” includes one or more of the following cases: semiautomated driving, highly automated driving, fully automated driving.

Semiautomated driving means that in a specific situation (for example: driving on an expressway, driving within a parking lot, passing an object, driving within a traffic lane, which is defined by lane markings) and/or for a certain period of time, longitudinal and lateral guidance of the motor vehicle are controlled remotely in an automatic manner. A driver of the motor vehicle does not have to manually control the longitudinal and lateral guidance of the motor vehicle himself/herself. However, the driver must monitor the automatic, remote control of the longitudinal and lateral guidance continuously, in order to be able to manually intervene, if necessary. The driver must be ready to completely take over the driving of the motor vehicle at any time.

Highly automated driving means that for a certain period of time, in a specific situation (for example: driving on an expressway, driving within a parking lot, passing an object, driving within a traffic lane, which is defined by lane markings), longitudinal and lateral guidance of the motor vehicle are controlled remotely in an automatic manner. A driver of the motor vehicle does not have to manually control the longitudinal and lateral guidance of the motor vehicle himself/herself. The driver does not have to monitor the automatic, remote control of the longitudinal and lateral guidance continuously, in order to be able to intervene manually, as required. If necessary, a take-over request to the driver for assuming the control of the longitudinal and lateral guidance is outputted automatically, in particular, outputted with adequate time to spare. Thus, the driver must be potentially able to take over the control of the longitudinal and lateral guidance. Limits of the automatic, remote control of the lateral and longitudinal guidance are detected automatically. In the case of highly automated driving, it is not possible to bring about a minimum-risk state automatically in every initial situation.

Fully automated driving means that in a specific situation (for example: driving on an expressway, driving within a parking lot, passing an object, driving within a traffic lane, which is defined by lane markings), longitudinal and lateral guidance of the motor vehicle are controlled remotely in an automatic manner. A driver of the motor vehicle does not have to manually control the longitudinal and lateral guidance of the motor vehicle himself/herself. The driver does not have to monitor the automatic, remote control of the longitudinal and lateral guidance, in order to be able to intervene manually, when necessary. Prior to an end of the automatic, remote control of the lateral and longitudinal guidance, a request for the driver to take over the driving task (controlling the lateral and longitudinal guidance of the motor vehicle) is made automatically, in particular, with adequate time to spare. If the driver does not assume the driving task, then a return is made automatically to a minimum-risk state. Limits of the automatic control of the lateral and longitudinal guidance are detected automatically. In all situations, it is possible to return automatically to a minimum-risk system state.

According to one specific embodiment of the present invention, it is provided that the at least one safety condition be, in each instance, an element selected from the following group of safety conditions: presence of a predetermined safety integrity level (SIL) or automotive safety integrity level (ASIL) of at least the motor vehicle and an infrastructure, in particular, including a communication path and/or communications components (for example, a communications interface), for controlling a motor vehicle remotely, in particular, with regard to the overall systems in the motor vehicle and infrastructure, as well as, in particular, parts, e.g., components, algorithms, interfaces, etc.; presence of a maximum latency time of a communication between the motor vehicle and a remote control device for controlling the motor vehicle remotely on the basis of the remote control signals; presence of a predetermined computer protection level of a device for executing the steps of the method according to the first aspect; presence of predetermined components and/or algorithms and/or communication options, which are used for executing the steps of the method according to the first aspect; presence of redundancy and/or diversity in predetermined components and/or algorithms and/or communication options, which are used for executing the steps of the method according to the first aspect; presence of predetermined availability information, which indicates an availability of predetermined components and/or algorithms and/or communication options; presence of predetermined quality criteria of the predetermined components and/or algorithms and/or communication options; presence of a plan, which includes measures for reducing faults, and/or measures in response to failures of predetermined components and/or algorithms and/or communication options, and/or measures for incorrect analyses and/or measures in response to incorrect interpretations; presence of one or more fallback scenarios; presence of a predetermined function; presence of a predetermined traffic situation; presence of predetermined weather, maximum possible time for a specific performance or execution of one step or a plurality of steps of the method according to the first aspect; presence of a test result, that elements or functions, which are used for executing the method according to the first aspect, are presently functioning correctly.

A communication path is, for example, a communication path between the device according to the second aspect, and the motor vehicle. A communication path includes, for example, one or more communication channels.

In one specific embodiment of the present invention, a component, which is used for executing the method according to the first aspect, is an element selected from the following group of components: surround sensor, motor vehicle, infrastructure, remote control device, device according to the second aspect, motor vehicle system, in particular, drive system, clutch system, brake system, driver assistance system, communications interface of the motor vehicle or of the infrastructure, processor, input, output of the device according to the second aspect.

In one specific embodiment of the present invention, a function, which is used for executing the method according to the first aspect, is an element selected from the following group of functions: remote control function, communication function between the motor vehicle and the infrastructure or the remote control device, evaluation function of surround sensor data of a surround sensor, planning function, in particular, travel planning function, traffic analysis function.

The following determines, in particular, a computer protection level: activated firewall and/or valid encryption certificate for encryption of a communication between the motor vehicle and the infrastructure or the remote control device, and/or activated virus program including current virus signatures, and/or presence of a protection, in particular, mechanical protection, in particular, anti-intrusion protection, of the computer, in particular, of the device according to the second aspect, or of the remote control device, and/or presence of an option for checking that signals, in particular, remote control signals or surrounding-area signals, have been transmitted correctly, that is, error-free.

An algorithm includes, for example, the computer program according to the third aspect.

Since, in particular, it is checked that redundancy and/or diversity is present in predetermined components and/or algorithms and/or communication options, for example, the technical advantage is provided, that in the case of failure of the corresponding component, for example, of a computer, or of the corresponding algorithm or the corresponding communication option, nevertheless, safe functioning may be implemented.

In order to ensure that results are correct, according to one specific embodiment of the present invention, these may be computed several times, for example, and the corresponding results may be compared to each other. For example, it is only determined that the results are correct, if the results agree. If an odd number occurs several times, it may then be determined, for example, that the result corresponding to the highest number of equal results is correct.

For example, the data signals are only generated, when it is able to be determined that the result is correct.

In one specific embodiment of the present invention, the data signals are only generated, if the at least one safety condition is satisfied.

According to one specific embodiment of the present invention, construction site condition signals are received, which represent at least one changed construction site condition; the data signals being generated on the basis of the at least one changed construction site condition.

This may produce, for example, the technical advantage that the data signals may be generated efficiently. In particular, this produces the technical advantage that changed construction site conditions may be responded to in an efficient manner. Thus, this means, in particular, that the data are generated on the basis of the changed construction site condition.

According to one specific embodiment of the present invention, at least one changed construction site condition is, in each instance, an element selected from the following group of construction site conditions: changed weather, changed construction site position, changed date, in particular, clock time, changed lighting conditions, changed visibility conditions, changed traffic conditions, changed road conditions, changed number of workers, who work at the road construction site, changed number of construction site vehicles that are present at the road construction site, changed traffic routing.

This may produce, for example, the technical advantage that particularly suitable, changed construction site conditions may be utilized.

According to one specific embodiment of the present invention, the method according to the first aspect is carried out, using a mobile construction site infrastructure. In accordance with an example embodiment of the present invention, the mobile construction site infrastructure includes the following:

a device, which is configured to execute all of the steps of the method (that is, the device according to the second aspect); a surround sensor system, which includes one or more spatially distributed surround sensors and is configured to monitor a surrounding area of the motor vehicle that includes at least part of the road construction site, in order to transmit surrounding-area signals, which correspond to the monitored surrounding area and represent the monitored surrounding area, to the device;

a wireless communications interface, which is configured to transmit a communication signal containing a communication message to the motor vehicle over a wireless communication network; the communication message including the data of the data signals outputted by the device; and

the method including adaptation of the construction site infrastructure in response to at least one changed construction site condition.

A technical advantage of this is, for example, that the method may be carried out efficiently.

Since, according to this specific embodiment of the present invention, the construction site infrastructure is adapted in response to at least one changed construction site condition, this produces, in particular, the technical advantage that changing construction site conditions may be responded to efficiently.

An adaptation of the construction site infrastructure means, in particular, that at least one element of the construction site infrastructure is adapted.

Elements of the construction site infrastructure include, for example, the device, the surround sensor system, in particular, the surround sensors, and the wireless communications interface.

According to one specific embodiment of the present invention, the adaptation includes at least one step selected from the following group of change steps: changing an orientation of a surround sensor, changing a position of a surround sensor, changing a signal strength of the communication signal, adapting an algorithm for generating the data signals.

This may produce, for example, the technical advantage that the adaptation may be carried out efficiently. In particular, this may produce the technical advantage that particularly suitable change steps may be provided.

An algorithm for generating the data signals denotes an algorithm, which is used in order to generate the data signals. If at least one construction site condition changes, then it may be useful to adapt the algorithm, as well.

The algorithm may include, for example, a calibration algorithm and/or a map algorithm and/or a travel plan algorithm.

In one specific embodiment of the present invention, after the data signals are outputted, in which case the data include a driving requirement that the motor vehicle is supposed to follow and the driving requirement includes remote control commands for controlling a lateral and/or longitudinal guidance of the motor vehicle remotely, remote control of the motor vehicle on the basis of the remote control commands is tested, in order to detect a fault; and in response to detection of a fault, the remote control is broken off, or emergency remote control signals for controlling the lateral and/or longitudinal guidance of the motor vehicle remotely in an emergency are generated and outputted.

The emergency remote control signals are, for example, such, that in the case of the remote control of the lateral and/or longitudinal guidance of the motor vehicle on the basis of the emergency remote control signals, the motor vehicle is carried over into a safe state, in particular, stopped.

In one specific embodiment of the present invention, after the data signals are outputted, in which case the data include a driving requirement that the motor vehicle is supposed to follow and the driving requirement includes remote control commands for controlling a lateral and/or longitudinal guidance of the motor vehicle remotely, remote control of the motor vehicle on the basis of the remote control commands is tested, in order to detect a fault; and in response to detection of a fault, the remote control is interrupted, or internal motor vehicle emergency control signals for controlling the lateral and/or longitudinal guidance of the motor vehicle in an emergency are generated and outputted.

The internal motor vehicle emergency control signals are, for example, such, that in the case of the control of the lateral and/or longitudinal guidance of the motor vehicle on the basis of the internal motor vehicle emergency control signals, the motor vehicle is carried over into a safe state, in particular, stopped.

Thus, internal motor vehicle emergency control signals are emergency control signals, which the motor vehicle generates itself and/or are generated in the motor vehicle.

For example, this may produce the technical advantage that in the event of a breakdown of communication, which corresponds, for example, to an emergency, between the motor vehicle and the device according to the second aspect, that is, a remote control device for controlling motor vehicles remotely, the motor vehicle may also carry itself over into a safe state.

Explanations, which are made in connection with the remote control commands and/or the internal motor vehicle emergency control signals, apply analogously to the emergency remote control signals, and vice versa.

According to one specific embodiment of the present invention, one or more method steps up to the steps of generating and outputting the data signals are executed in the motor vehicle, and/or one or more method steps are executed outside of the motor vehicle, in particular, in an infrastructure, preferably, in a cloud infrastructure and/or in a construction site infrastructure.

This may produce, for example, the technical advantage that the corresponding method steps may be carried out in an efficiently redundant manner. In particular, this may further increase safety in an advantageous manner.

According to one specific embodiment of the present invention, one or more method steps are documented, in particular, documented in a blockchain.

This may produce, for example, the technical advantage that on the basis of the documentation, this may also be analyzed subsequently after the performance or execution of the method. In particular, the documentation in a blockchain has the technical advantage that the documentation is safe from manipulation and falsification.

A blockchain (also block chain) is, in particular, a continuously expandable list of data records, called blocks, which are linked together with the aid of one or more cryptographic methods. In this context, each block contains, in particular, a cryptographically secure hash (standard value of deviation) of the preceding block, in particular, a time stamp and, in particular, transactional data.

One illustrative application may include, for example, one or more of the following specific embodiments and/or features and/or examples:

In one specific embodiment of the present invention, it is determined that a motor vehicle is driving towards the road construction site.

For example, information signals are received, which represent an information item, that a motor vehicle is driving towards the road construction site. For example, the information signals are transmitted by the motor vehicle. Based on the information signals, it is determined, for example, that a motor vehicle is driving towards the road construction site. For example, the motor vehicle emits a signal and is detected in this manner. Thus, this means, in particular, that the motor vehicle may emit a signal, for example, a positional signal. In response to such a signal, for example, it is determined that a motor vehicle is driving towards the road construction site.

For example, the surrounding-area signals are processed, in particular, with the aid of the construction site infrastructure, in order to detect a motor vehicle driving towards the road construction site. The motor vehicle may be detected, for example, using its license plate. The processing of the surrounding-area signals includes, in particular, license plate detection.

For example, the motor vehicle is connected to the construction site infrastructure so as to be able to communicate, or it is connected (automatically) to the construction site infrastructure in front of the road construction site so as to be able to communicate (in particularly, automatically).

The construction site infrastructure includes, for example, the device according to the second aspect. The construction site infrastructure includes, for example, one or more spatially distributed surround sensors for monitoring the road construction site and/or a start of a road construction site and/or an end of a road construction site and/or a surrounding area of the road construction site.

For example, a construction site situation and/or the motor vehicle and/or a position of the motor vehicle are analyzed, in particular, with the aid of the construction site infrastructure.

For example, the motor vehicle is located.

Motor vehicle data are sent by the motor vehicle, for example, automatically/for example, by request. Motor vehicle data include, for example, positional data, in particular, GPS data, and/or motor vehicle speed data.

The construction site infrastructure detects the motor vehicle, for example, with the aid of visual infrastructure sensors, that is, surround sensors, for example, video sensors.

For example, the motor vehicle transmits its travel route to the device according to the second aspect.

For example, travel route signals are received, which represent a travel route of the motor vehicle. The travel route includes, for example, a motor vehicle speed along the travel route.

For example, a traffic event is analyzed, in particular, with the aid of the construction site infrastructure, especially, with the aid of the device according to the second aspect.

The analyzing of the traffic event includes, for example, processing of motor vehicle data transmitted by further motor vehicles, and/or processing, for example, visual analysis, of the surround sensor data of the surround sensors of the construction site infrastructure.

In one specific embodiment of the present invention, data, which are suitable for assisted traversal of the road construction site by the motor vehicle, are ascertained.

In one specific embodiment of the present invention, the data include a driving requirement. In particular, the driving requirement remote control commands for controlling the lateral and/or longitudinal guidance of the motor vehicle remotely.

One driving requirement includes a construction site travel route through the road construction site. In particular, the driving requirement includes a speed characteristic along the construction site travel route.

The data are transmitted, for example, to the motor vehicle via a wireless communications network.

The example method according to the first aspect is carried out, for example, during a trip of the motor vehicle, that is, without stopping the motor vehicle, e.g., for transferring the motor vehicle guidance from the motor vehicle and/or from the driver to the construction site infrastructure.

According to one specific embodiment of the present invention, if, for example, a hazard is determined during the implementation of the method according to the first aspect, then at least one of the following actions and/or steps is initiated and/or performed:

The motor vehicle is stopped for safety reasons, and, in particular, a solution is subsequently sought.

For example, other road users, in particular, motor vehicles, in the surroundings of the motor vehicle are informed about the hazard. The informing is carried out, for example, over V2I communication systems. The informing is carried out, for example, via information systems outside of the motor vehicle, such as signs and/or audio systems.

For example, a traffic guidance system including, for example, traffic systems, in particular, traffic lights and/or indicator systems, is used, that is, controlled, in order to assist the motor vehicle in its transit through the road construction site.

The method steps are preferably documented in a comprehensible manner safe from falsification, in particular, in a block chain.

In one specific embodiment of the present invention, the traversal of the road construction site by the motor vehicle is assisted by a person included in the construction site infrastructure.

According to one specific embodiment of the present invention, it is provided that the method according to the first aspect be a computer-implemented method.

According to one specific embodiment of the present invention, the method according to the first aspect is executed or performed with the aid of the device according to the second aspect.

Device features follow analogously from corresponding method features, and vice versa. Thus, this means that, in particular, technical functions of the device according to the second aspect follow analogously from corresponding instances of technical functionality of the method according to the first aspect, and vice versa.

The wording “at least one” stands, in particular, for “one or more.”

The terms traffic lane and lane may be used synonymously.

Exemplary embodiments of the present invention are represented in the figures and explained in greater detail in the description below.

### BRIEF DESCRIPTION OF THE DRAWINGS

FIG. 1 show a flow chart of an example method according to the first aspect of the present invention.

FIG. 2 shows an example device according to the second aspect of the present invention.

FIG. 3 shows an example machine-readable storage medium.

FIG. 4 shows a road construction site in accordance with an example embodiment of the present invention.

### DETAILED DESCRIPTION OF EXAMPLE EMBODIMENTS

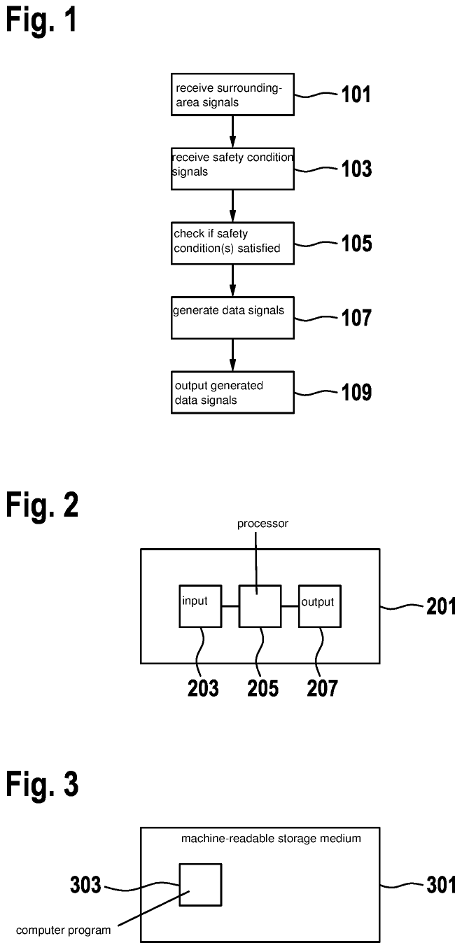

FIG. 1 shows a flow chart of a method of assisting a motor vehicle driven in an at least semiautomated manner, for passing through and/or while passing through a road construction site; the method including the following steps:

receiving 101 surrounding-area signals that represent a surrounding area of the motor vehicle, the surrounding area of the motor vehicle including at least a part of a road construction site;

receiving 103 safety condition signals, which represent at least one safety condition that must be satisfied, so that the motor vehicle may be assisted from outside of the motor vehicle while passing through the road construction site;

checking 105 if the at least one safety condition is satisfied;

generating 107 data signals, which represent data suitable for assisted traversal of the road construction site by the motor vehicle, based on the surrounding-area signals, and based on a result of whether the at least one safety condition is satisfied;

outputting 109 the generated data signals.

According to one specific embodiment of the present invention, the data include a driving requirement, which the motor vehicle is supposed to follow.

According to one specific embodiment of the present invention, the driving requirement includes remote control commands for controlling a lateral and/or longitudinal guidance of the motor vehicle remotely.

According to one specific embodiment of the present invention, the method according to the first aspect includes controlling a lateral and/or longitudinal guidance of the motor vehicle remotely on the basis of the remote control commands.

According to one specific embodiment of the present invention, the result as to whether the at least one safety condition is satisfied, indicates that the at least one safety condition is or is not satisfied.

The specific embodiment is provided, in which the data signals are only generated, if the result as to whether the at least one safety condition is satisfied, indicates that the at least one safety condition is satisfied.

If the at least one safety condition is not satisfied, then, for example, the generation of data signals is refrained from.

For example, the driving requirement only includes remote control commands for controlling a lateral and/or longitudinal guidance of the motor vehicle remotely, if the result as to whether the at least one safety condition is satisfied, indicates that the at least one safety condition is satisfied. Alternatively, for example, the driving requirement does not include remote control commands for controlling a lateral and/or longitudinal guidance of the motor vehicle remotely.

Therefore, this means, in particular, that the remote control of a lateral and/or longitudinal guidance of the motor vehicle is refrained from, if the at least one safety condition is not satisfied.

FIG. 2 shows a device 201 in accordance with an example embodiment of the present invention.

Device 201 is configured to execute all of the steps of the method according to the first aspect.

Device 201 includes an input 203, which is configured to receive the surrounding-area signals and the safety condition signals.

Device 201 further includes a processor 205, which is configured to execute the checking step and the generating step.

For example, processor 205 is configured to determine, based on the surrounding-area signals, that a motor vehicle intends to pass through a road construction site.

Device 201 further includes an output 207, which is configured to output the data signals generated.

According to one specific embodiment of the present invention, for example, outputting the generated data signals includes transmitting the data signals over a communications network, in particular, over a wireless communications network, to the motor vehicle.

Processor 205 is configured, for example, to process the surrounding-area signals, in order to detect a motor vehicle situated in a surrounding area of the road construction site. For example, in response to the detection of a motor vehicle situated in the surrounding area of the road construction site, processor 205 is configured to determine that a motor vehicle intends to pass through the road construction site.

In general, signals, which are received, are received with the aid of input 203. Thus, input 203 is configured, in particular, to receive the corresponding signals.

In general, signals, which are outputted, are outputted with the aid of output 207. Thus, output 207 is configured, in particular, to output the corresponding signals.

According to one specific embodiment of the present invention, a plurality of processors are provided in place of the one processor 205.

According to one specific embodiment of the present invention, processor 205 is configured to execute the generating and/or checking and/or determining steps described above and/or in the following.

According to one specific embodiment of the present invention, device 201 is part of an infrastructure, in particular, cloud infrastructure, for example, part of a construction site infrastructure.

FIG. 3 shows an example machine-readable storage medium 301.

A computer program 303 is stored in machine-readable storage medium 301; the computer program including commands, which, in response to execution of the computer program by a computer, cause it to implement a method according to the first aspect of the present invention.

According to one specific embodiment of the present invention, device 201 includes a remote control device, which is configured to control a lateral and/or longitudinal guidance of motor vehicles remotely on the basis of remote control commands. Thus, this means, in particular, that the remote control device is configured, in particular, to control the motor vehicle remotely on the basis of the remote control commands, that is, to control the lateral and/or longitudinal guidance of the motor vehicle remotely on the basis of the remote control commands.

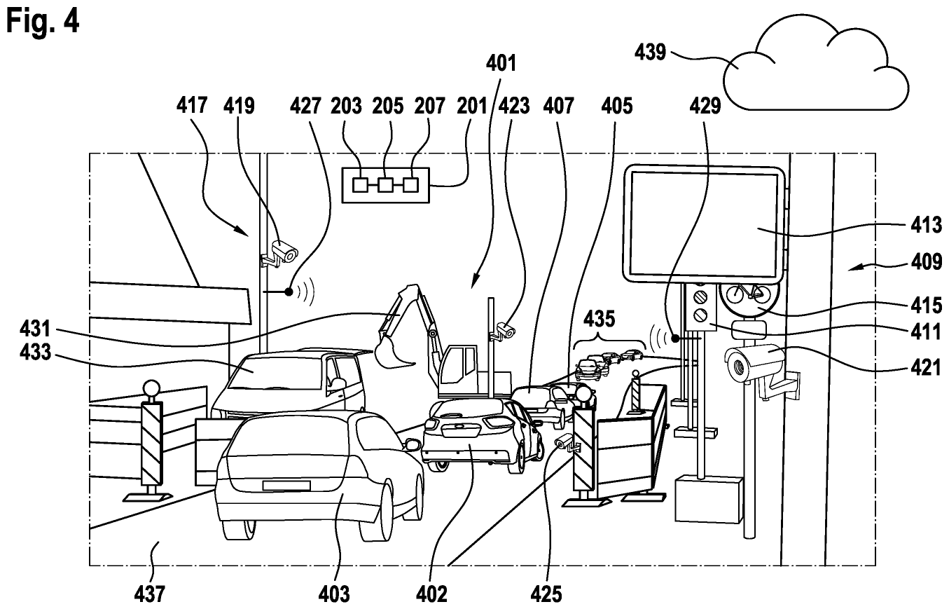

FIG. 4 shows a road construction site 401.

A first motor vehicle 402, a second motor vehicle 403, a third motor vehicle 405, and a fourth 407 travel through road construction site 401, driven in an at least semiautomated manner.

In a specific embodiment not shown, for example, one of these motor vehicles may travel through road construction site 401, driven manually by a driver.

Road construction site 401 includes a construction site infrastructure 409.

Construction site infrastructure 409 includes a traffic light 411, which controls traffic that moves through road construction site 401.

Construction site infrastructure 409 further includes device 201 according to FIG. 2.

Traffic light 411 is partially covered by a place name sign 413 and at least partially covered by a traffic sign 415.

This coverage may result in, for example, surround sensors (not shown) of the motor vehicles 401, 403, 405, 407 driven in an at least semiautomated manner, not detecting traffic light 411 or having difficulties in detecting a signal pattern of traffic light 411.

Construction site infrastructure 409 further includes a surround sensor system 417 having a first video camera 419, a second video camera 421, a third video camera 423 and a fourth video camera 425, which are positioned so as to be spatially distributed within road construction site 401. Each of video cameras 419, 421, 423, 425 includes a video sensor (not shown).

In one specific embodiment not shown, for example, further surround sensors are provided in place of, or in addition to, the video sensors of the video cameras.

In the spirit of the description, a surround sensor is generally one of the following surround sensors: radar sensor, lidar sensor, ultrasonic sensor, magnetic field sensor, infrared sensor, and video sensor, in particular, video sensor of a video camera.

Construction site infrastructure 409 further includes a first wireless communications interface 427 and a second wireless communications interface 429.

A first construction site vehicle 431, which is an excavator, and a second construction site vehicle 433, which is a van, are situated within road construction site 401.

Oncoming traffic with respect to the four motor vehicles 402, 403, 405, 407 is represented with the aid of a brace having the reference numeral 435; this oncoming traffic having to wait. This is because only a single traffic lane 437 runs through road construction site 401.

Oncoming traffic 435 is controlled by a traffic light (not shown) in a manner analogous to the four motor vehicles 402, 403, 405, 407.

In the present exemplary embodiment, it displays a red signal at the time shown.

Construction site infrastructure 409 further includes a cloud infrastructure 439. In one specific embodiment not shown, it is provided that device 201 be part of cloud infrastructure 439.

Method steps of the example method according to the first aspect may be executed, for example, in cloud infrastructure 439.

The video signals of video cameras 419, 421, 423, 425 are provided, for example, to device 201.

These video signals are, for example, an example of surrounding-area signals.

That is to say, in the spirit of the description, these video signals may be encompassed by surrounding-area signals.

For example, for motor vehicles 402, 403, 405, 407, remote control commands for controlling a specific lateral and/or longitudinal guidance of these motor vehicles remotely are generated on the basis of these video signals.

For example, with the aid of first and/or second wireless communications interface 427, 429, these remote control commands are transmitted over a wireless communications network to motor vehicles 402, 403, 405, 407.

For example, in one specific embodiment of the present invention, the data, which are ascertained with the aid of processor 205, include signal pattern data that represent a signal pattern of traffic light 411.

Thus, this means, in particular, that the signal pattern of traffic light 411 may be transmitted over the wireless communications network to the four motor vehicles 402, 403, 405, 407.

This may produce, for example, the technical advantage that in spite of the at least partial masking of traffic light 411 by place name sign 413 and/or traffic sign 415, these motor vehicles obtain knowledge about the signal pattern of traffic light 411.

One condition for generating the data signals in conformance with the method according to the first aspect is, in particular, that the at least one safety condition is satisfied.

For example, for controlling motor vehicles 402, 403, 405, 407 remotely, a latency time for transmitting the remote control commands over the wireless communications network with the aid of wireless communications interfaces 427, 429 must be less than or less than or equal to a predetermined threshold latency time value.

For example, a motor vehicle, which may be controlled remotely on the basis of remote control commands, must have a predetermined safety integrity level.

According to one specific embodiment of the present invention, a condition for controlling the lateral and/or longitudinal guidance of motor vehicles remotely, that is, in particular, for controlling the lateral and/or longitudinal guidance of the motor vehicle remotely, is that the remote control is safe. In the spirit of the description, “safe” means, in particular, “safe” and “secure.” Actually, these two English terms are normally translated into German as “sicher.” Nevertheless, these have a partially different meaning in English.

The term “safe” is directed, in particular, to the topic of accident and accident prevention. Remote control, which is “safe,” causes, in particular, a probability of an accident or a collision to be less than or less than or equal to a predetermined threshold probability value.

The term “secure” is directed, in particular, to the topic of computer protection and/or hacker protection, that is, in particular, how securely is an (a) (computer) infrastructure and/or a communications infrastructure, in particular, a communication path between a motor vehicle and a remote control device for controlling a motor vehicle remotely, protected from unauthorized access and/or from data manipulation by a third party (hacker).

Thus, remote control, which is “secure,” has, in particular, appropriate and sufficient computer protection and/or hacker protection as a basis.

For example, according to one specific embodiment of the present invention, it is tested if the entity made up of a motor vehicle and infrastructure involved in the method according to the first aspect, including communication between the infrastructure and the motor vehicle, is currently secure for the plan, “intervention in the motor vehicle for critical actions, specific application: road construction site” described here. Therefore, this means, in particular, that the motor vehicle and/or a local and/or a global infrastructure and/or a communication are appropriately tested. The data signals, in particular, the remote control commands, are generated, in particular, on the basis of a result of the testing.

Thus, this means, in particular, that the components, which are used during the execution of the method according to the first aspect, are tested for safety, that is, as to whether these satisfy specific safety conditions, before the intervention in the vehicle operation is carried out, that is, before the motor vehicle is controlled remotely.

Important or dependent criteria include, for example, one or more of the safety conditions described above.

According to one specific embodiment of the present invention, first of all, the overall system (motor vehicle, infrastructure, for example, construction site infrastructure, communication path, cloud, . . . ) is tested with regard to the safety condition.

According to one specific embodiment of the present invention, the individual parts are also tested with regard to satisfying the safety condition. This, in particular, prior to the remote control of the motor vehicle.

In this context, in one specific embodiment of the present invention, the testing step(s) are executed inside the motor vehicle and/or outside the motor vehicle, in particular, in an infrastructure, for example, construction site infrastructure.

According to one specific embodiment of the present invention, the checking step(s) are tested subsequently, that is, at a later time, for example, at regular intervals. For example, the testing step(s) are tested subsequently at a predetermined frequency, for example, every 100 ms.

For example, according to one specific embodiment of the present invention, this testing, that is, the test as to whether the at least one safety condition is satisfied, takes place prior to and/or after and/or during one or more predetermined method steps.

According to one specific embodiment of the present invention, the testing is carried out or executed in response to problems.

1-11. (canceled)

12. A method of assisting a motor vehicle driven in an at least semiautomated manner, for passing through a road construction site, the method comprising the following steps:
receiving surrounding-area signals that represent a surrounding area of the motor vehicle, the surrounding area of the motor vehicle including at least part of a road construction site;
receiving safety condition signals, which represent at least one safety condition that must be satisfied, so that the motor vehicle may be assisted from outside of the motor vehicle while passing through the road construction site;
checking whether the at least one safety condition is satisfied;
generating data signals, which represent data suitable for assisted traversal of the road construction site by the motor vehicle, based on the surrounding-area signals, and based on a result of whether the at least one safety condition is satisfied; and
outputting the generated data signals.

13. The method as recited in claim 12, wherein the data include a driving requirement that the motor vehicle is supposed to follow.

14. The method as recited in claim 13, wherein the driving requirement includes remote control commands for remotely controlling a lateral and/or longitudinal guidance of the motor vehicle.

15. The method as recited in claim 14, wherein the at least one safety condition is, in each instance, an element selected from the following groups of safety conditions:
(i) presence of a predetermined safety integrity level or automotive safety integrity level of at least the motor vehicle and an infrastructure, including a communication path and/or communications components, for remotely controlling the motor vehicle;
(ii) presence of a maximum latency time of a communication between the motor vehicle and a remote control device for remotely controlling the motor vehicle based on the remote control signals;
(iii) presence of a predetermined computer protection level of a device for executing the steps of the method;
(iv) presence of predetermined components and/or algorithms and/or communication options, which are used for executing the steps of the method;
(v) presence of redundancy and/or diversity in predetermined components and/or algorithms and/or communication options, which are used for executing the steps of the method;
(vi) presence of predetermined availability information, which indicates an availability of predetermined components and/or algorithms and/or communication options;
(vii) presence of predetermined quality criteria of the predetermined components and/or algorithms and/or communication options;
(viii) presence of a plan, which includes measures for reducing faults and/or measures in response to failures of predetermined components and/or algorithms and/or communication options and/or measures for incorrect analyses and/or measures in response to incorrect interpretations;
(ix) presence of one or more fallback scenarios;
(x) presence of a predetermined function;
(xi) presence of a predetermined traffic situation;
(xii) presence of predetermined weather,
(xiii) maximum possible time for a specific performance or execution of one or more steps of the method;
(xiv) presence of a test result, that elements or functions, which are used for executing the method, are presently functioning correctly.

16. The method as recited in claim 12, wherein construction site condition signals are received, which represent at least one changed construction site condition, and the data signals are generated based on the at least one changed construction site condition.

17. The method as recited in claim 16, wherein the at least one changed construction site condition is, in each instance, an element selected from the following group of construction site conditions:
(i) changed weather;
(ii) changed construction site position;
(iii) changed date;
(iv) changed clock time;
(v) changed lighting conditions;
(vi) changed visibility conditions;
(vii) changed traffic conditions;
(viii) changed road conditions;
(ix) changed number of workers who work at the road construction site;
(x) changed number of construction site vehicles which are present at the road construction site;
(xi) changed traffic routing.

18. The method as recited in claim 17, wherein the method is carried out using a mobile construction site infrastructure, the mobile construction site infrastructure including the following:
(i) a device configured to execute all of the steps of the method; and
(ii) a surround sensor system, which includes one or more spatially distributed surround sensors and is configured to monitor a surrounding area of the motor vehicle that includes at least part of the road construction site, in order to transmit to the device surrounding-area signals, which correspond to the monitored surrounding area and represent the monitored surrounding area; and
(iii) a wireless communications interface which is configured to transmit a communication signal containing a communication message to the motor vehicle over a wireless communications network, the communication message including the data of the data signals outputted by the device;
wherein the method further comprising an adaptation of the construction site infrastructure in response to at least one changed construction site condition.

19. The method as recited in claim 18, wherein the adaptation includes at least one step selected from the following group of change steps: (i) changing an orientation of a surround sensor, (ii) changing a position of a surround sensor, (iii) changing a signal strength of the communication signal, (iv) adapting an algorithm for generating the data signals.

20. A device configured to assist a motor vehicle driven in an at least semiautomated manner, for passing through a road construction site, the device configured to:
receive surrounding-area signals that represent a surrounding area of the motor vehicle, the surrounding area of the motor vehicle including at least part of a road construction site;
receive safety condition signals, which represent at least one safety condition that must be satisfied, so that the motor vehicle may be assisted from outside of the motor vehicle while passing through the road construction site;
check whether the at least one safety condition is satisfied;
generate data signals, which represent data suitable for assisted traversal of the road construction site by the motor vehicle, based on the surrounding-area signals, and based on a result of whether the at least one safety condition is satisfied; and
output the generated data signals.

21. A non-transitory machine-readable storage medium on which is stored a computer program assisting a motor vehicle driven in an at least semiautomated manner, for passing through a road construction site, the computer program, when executed by a computer, causing the computer to perform the following steps:
receiving surrounding-area signals that represent a surrounding area of the motor vehicle, the surrounding area of the motor vehicle including at least part of a road construction site;
receiving safety condition signals, which represent at least one safety condition that must be satisfied, so that the motor vehicle may be assisted from outside of the motor vehicle while passing through the road construction site;
checking whether the at least one safety condition is satisfied;
generating data signals, which represent data suitable for assisted traversal of the road construction site by the motor vehicle, based on the surrounding-area signals, and based on a result of whether the at least one safety condition is satisfied; and
outputting the generated data signals.
